(19) United States
(12) Patent Application Publication
(10) Pub. No.: US 2019/0213165 A1
(43) Pub. Date: Jul. 11, 2019

(54) PRIORITY SCHEME FOR FAST ARBITRATION PROCEDURES

(71) Applicant: QUALCOMM Incorporated, San Diego, CA (US)

(72) Inventors: Radu PITIGOI-ARON, San Jose, CA (US); Lalan Jee MISHRA, San Diego, CA (US); Richard Dominic WIETFELDT, San Diego, CA (US)

(21) Appl. No.: 16/201,250

(22) Filed: Nov. 27, 2018

Related U.S. Application Data
(60) Provisional application No. 62/615,241, filed on Jan. 9, 2018.

(51) Int. Cl. G06F 13/42

(52) U.S. Cl. CPC G06F 13/4291; G06F 2213/0016

(57) ABSTRACT

Systems, methods, and apparatus for serial bus arbitration are described. A method for arbitrating access to a serial bus includes providing a clock signal on a first line of the serial bus, configuring a line driver coupled to a second line of the serial bus for open-drain operation, transmitting an address header through the line driver in accordance with timing provided by the clock signal, detecting that the second line is driven low in a bit interval corresponding to the at least one most-significant bit, configuring the line driver for push-pull operation after detecting that the second line has been driven low, and increasing rate at which clock pulses are provided in the clock signal after detecting that the second line has been driven low. The address header may include at least one most-significant bit that has a zero-value when a high-priority device is addressed.

### PRIORITY CLAIM

This application claims priority to and the benefit of U.S. Provisional Patent Application Ser. No. 62/615,241 filed in the U.S. Patent Office on Jan. 9, 2018, the entire content of this application being incorporated herein by reference as if fully set forth below in its entirety and for all applicable purposes.

### TECHNICAL FIELD

The present disclosure relates generally to an interface between processing circuits and peripheral devices and, more particularly, to improving latency on a serial bus that support arbitration for access to a serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

In another example, the protocols used on an I3C bus derives certain implementation aspects from the I2C protocol. The I3C bus are defined by the Mobile Industry Processor Interface Alliance (MIPI). Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation.

The I3C bus employs an arbitration scheme that involves the use of relatively slow open-drain line drivers. Accordingly, arbitration processes and/or opportunities can degrade latency on the serial bus. As applications have become more complex, demand for reduced response time has escalated and there is a continuing demand for improved bus management techniques that can reduce bus latency.

### SUMMARY

Certain aspects of the disclosure relate to systems, apparatus, methods and techniques that enable alerts and/or requests for bus arbitration to be sent in a first direction over a serial bus while a datagram is being transmitted in a second direction over the serial bus.

In various aspects of the disclosure, a method for arbitrating access to a serial bus includes providing a clock signal on a first line of the serial bus, configuring a line driver coupled to a second line of the serial bus for open-drain operation, transmitting an address header through the line driver in accordance with timing provided by the clock signal, detecting that the second line is driven low in a bit interval corresponding to the at least one most-significant bit, configuring the line driver for push-pull operation after detecting that the second line has been driven low, and increasing rate at which clock pulses are provided in the clock signal after detecting that the second line has been driven low. The address header may include at least one most-significant bit that has a zero-value when a high-priority device is addressed.

In some aspects, a data transfer involving the high-priority device may be initiated after detecting that the second line has been driven low. The data transfer may be initiated after completion of transmission of the address header.

In one or more aspects, the method includes causing a data exchange involving the high-priority device and a slave device after detecting that the second line has been driven low. The data exchange may be initiated after completion of transmission of the address header.

In one aspect, the method includes transmitting a stop condition configured to terminate transmission of the address header after detecting that the second line has been driven low, and initiating a transaction to read data from and/or write data to the high-priority device after transmitting the stop condition.

In one aspect, the method includes driving the second line low for at least one cycle of the clock signal after detecting that the second line has been driven low, and initiate a transaction to write data to the high-priority device after expiration of the at least one cycle of the clock signal.

In one aspect, the method includes transmitting a repeated start condition after detecting that the second line has been driven low, where the repeated start condition is configured to terminate transmission of the address header, and initiating a transaction to read data from a slave device other than the high-priority device after transmitting the stop condition.

In one aspect two or more high-priority devices are coupled to the serial bus. Each high-priority device may be configured with a device address that has one zero-value most-significant bit. Two or more high-priority devices may be configured with device addresses that have different zero-value most-significant bits.

In various aspects of the disclosure, an apparatus includes a bus interface configured to couple the apparatus to a serial bus having a first line configured to carry a clock signal, the bus interface including a line driver adapted to drive a second line of the serial bus. The apparatus includes a controller configured to provide the clock signal, configure the line driver for open-drain operation, transmit an address header through the line driver in accordance with timing provided by the clock signal, where the address header includes at least one most-significant bit that has a zero-value when a high-priority device is addressed, detect that the second line is driven low in a bit interval corresponding to the at least one most-significant bit, configure the line driver for push-pull operation after detecting that the second line has been driven low, and increase rate at which clock pulses are provided in the clock signal after detecting that the second line has been driven low.

In various aspects of the disclosure, an apparatus includes means for providing a clock signal on a first line of a serial bus that provides multiple data lanes, means for configuring a line driver coupled to a second line of the serial bus for open-drain operation, means for transmitting an address header through the line driver in accordance with timing provided by the clock signal, the address header including at least one most-significant bit that has a zero-value when a high-priority device is addressed, means for detecting that the second line is driven low in a bit interval corresponding to the at least one most-significant bit, means for configuring the line driver for push-pull operation after detecting that the second line has been driven low, and means for increasing rate at which clock pulses are provided in the clock signal after detecting that the second line has been driven low.

In various aspects of the disclosure, a computer-readable medium stores code, instructions and/or data, including code which, when executed by a processor, causes the processor to provide a clock signal on a first line of a serial bus that provides multiple data lanes, configure a line driver coupled to a second line of the serial bus for open-drain operation, transmit an address header through the line driver in accordance with timing provided by the clock signal, The address header may include at least one most-significant bit that has a zero-value when a high-priority device is addressed, detect that the second line is driven low in a bit interval corresponding to the at least one most-significant bit, configure the line driver for push-pull operation after detecting that the second line has been driven low, and increase rate at which clock pulses are provided in the clock signal after detecting that the second line has been driven low.

### BRIEF DESCRIPTION OF THE DRAWINGS

FIG. 1 illustrates an apparatus employing a data link between IC devices that is selectively operated according to one of plurality of available standards.

FIG. 2 illustrates a communication interface in which a plurality of devices is connected using a serial bus.

FIG. 3 illustrates certain aspects of an apparatus that includes multiple devices connected to a serial bus.

FIG. 4 illustrates certain aspects of the timing relationship between SDA and SCL wires on a conventional I2C bus.

FIG. 5 is a timing diagram that illustrates timing associated with multiple frames transmitted on an I2C bus.

FIG. 6 illustrates timing related to a command word sent to a slave device in accordance with I2C protocols.

FIG. 7 includes a timing diagram that illustrates an example of signaling on a serial bus when the serial bus is operated in a mode of operation defined by I3C specifications.

FIG. 8 illustrates address headers transmitted in accordance with I3C protocols.

FIG. 9 illustrates certain aspects of timing related to address arbitration involving devices configured in accordance with certain aspects disclosed herein.

FIG. 10 is a table illustrating a first addressing scheme that may be employed in accordance with certain aspects disclosed herein.

FIG. 11 is a table illustrating a second addressing scheme that may be employed in accordance with certain aspects disclosed herein.

FIG. 12 is a first flowchart illustrating certain aspects of an arbitration priority scheme for low latency applications coupled to a serial bus in accordance with certain aspects disclosed herein.

FIG. 13 is a block diagram illustrating an example of an apparatus employing a processing circuit that may be adapted according to certain aspects disclosed herein.

FIG. 14 is a second flowchart illustrating certain aspects of an arbitration priority scheme for low latency applications coupled to a serial bus in accordance with certain aspects disclosed herein.

FIG. 15 illustrates a hardware implementation for an apparatus adapted that supports an arbitration priority scheme for low latency applications coupled to a serial bus in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a serial bus to connect application processor or other host device with modems and other peripherals. The serial bus may be operated in accordance with specifications and protocols defined by a standards body. The serial bus may be operated in accordance with a standard or protocol such as the I2C and/or I3C protocol that defines timing relationships between signals and transmissions. Certain aspects disclosed herein relate to systems, apparatus, methods and techniques that provide an arbitration scheme that can be used on a serial bus to minimize latency for high priority devices and improve overall link performance.

A device coupled to a serial bus, which is operated according to certain bus protocols, can participate in an address arbitration process to gain access to the bus. Certain deterministic applications have strict requirements for latency that may be jeopardized when a device cannot quickly access the serial bus because conventional arbitration protocols may consume the same amount of time irrespective of the priority of the device seeking access to the bus. For example, the header or the address of a transaction is arbitrable in many bus protocols, including I2C and the I3C protocols. More than one device may attempt to drive a line of the serial bus during arbitration, and devices may operate their line drivers in an open-drain mode during arbitration, such that the arbitration functions as a wired-AND process. Open-drain driving modes are inherently among the slowest operations performed over the serial bus, because the control line is pulled a High voltage level by a pull-up structure.

According to certain aspects disclosed herein, an addressing scheme is implemented that enables a master device to quickly recognize the addresses of one or more high priority devices during arbitration. The master device may treat a high-priority address as an early indication of end of arbitration, and both master and slave devices may exit open-drain driving mode and resume push-pull mode of its line driver.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

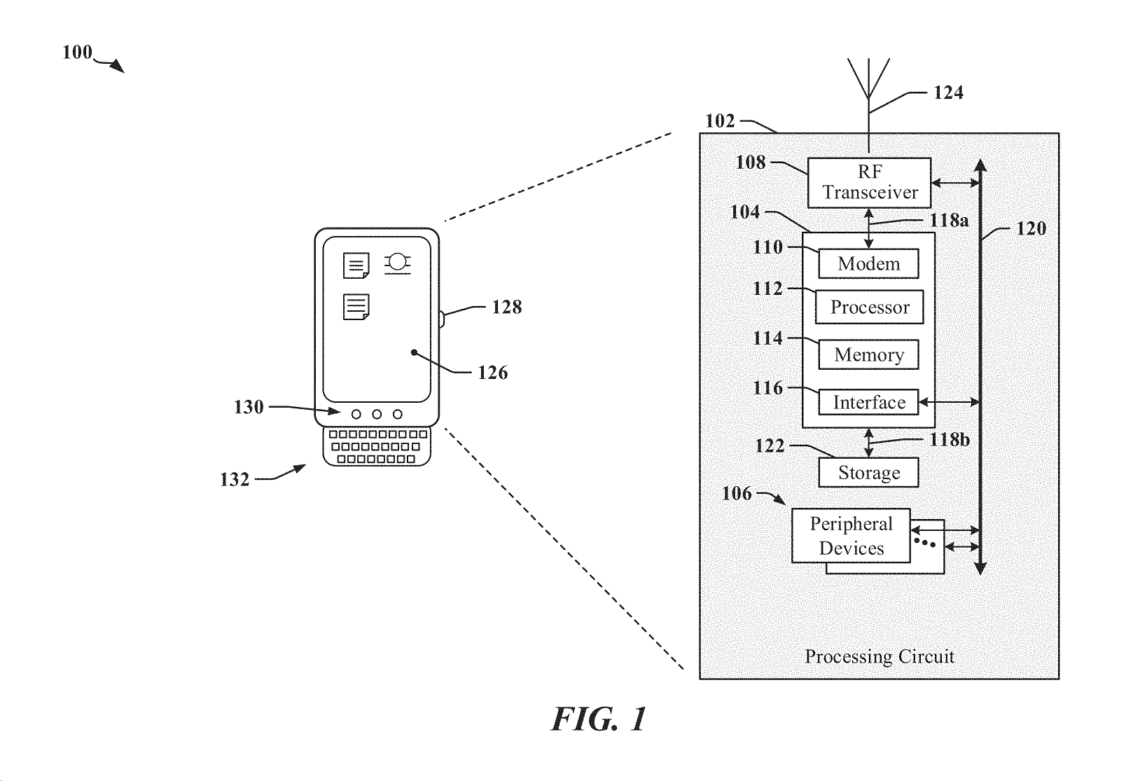

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

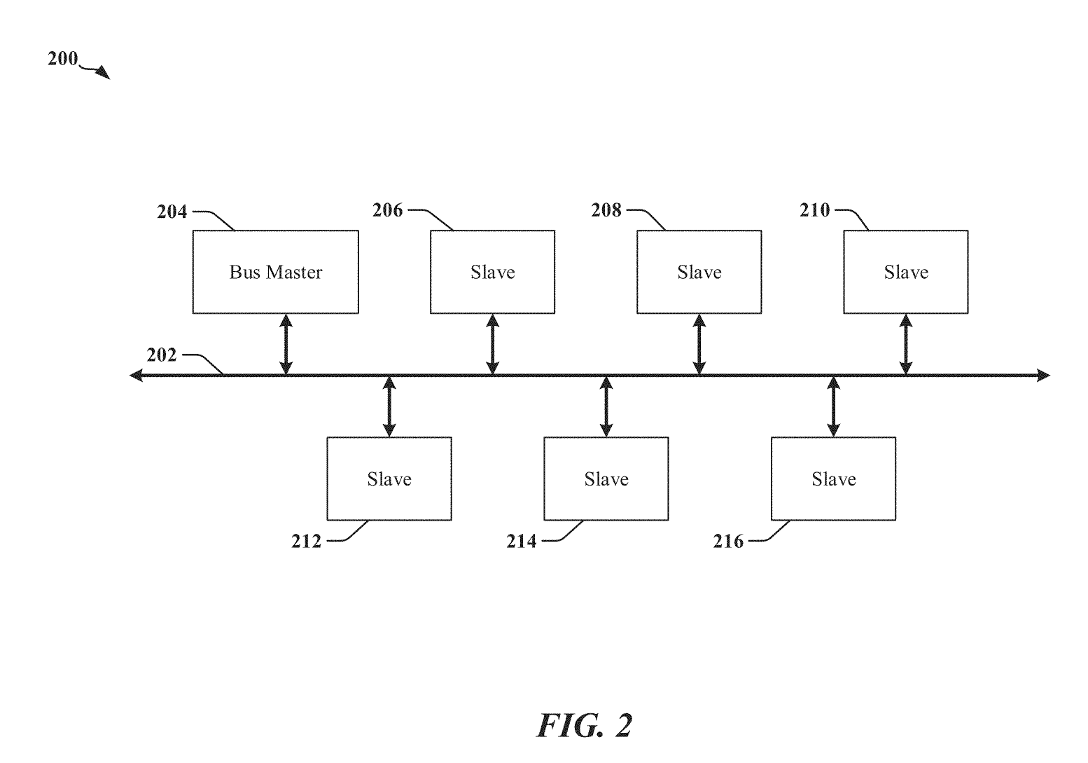

FIG. 2 illustrates a communication link 200 in which a configuration of devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols, where timing information is embedded in the transmission of the symbols.

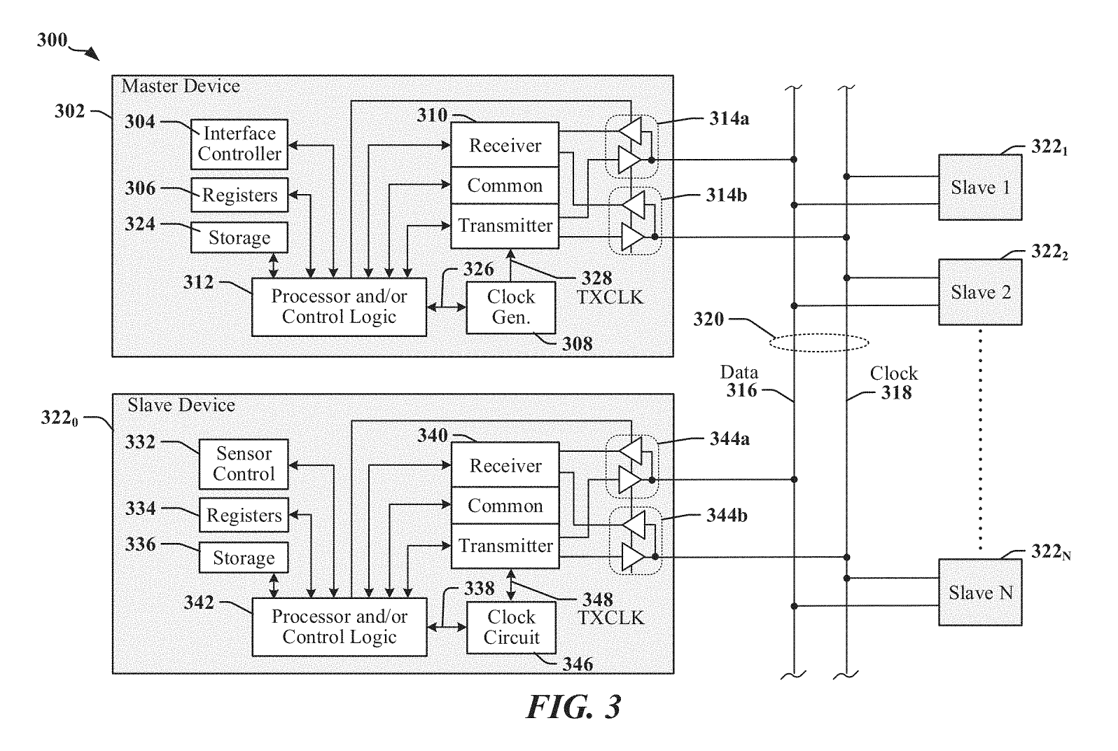

FIG. 3 illustrates certain aspects of an apparatus 300 that includes multiple devices 302, and 322₀-322_{N} coupled to a serial bus 320. The devices 302 and 322₀-322_{N} may be implemented in one or more semiconductor IC devices, such as an applications processor, SoC or ASIC. In various implementations the devices 302 and 322₀-322_{N} may include, support or operate as a modem, a signal processing device, a display driver, a camera, a user interface, a sensor, a sensor controller, a media player, a transceiver, and/or other such components or devices. In some examples, one or more of the slave devices 322₀-322_{N} may be used to control, manage or monitor a sensor device. Communications between devices 302 and 322₀-322_{N} over the serial bus 320 is controlled by a bus master 302. Certain types of bus can support multiple bus master devices 302.

In one example, a bus master device 302 may include an interface controller 304 that may manage access to the serial bus, configure dynamic addresses for slave devices 322₀-322_{N} and/or generate a clock signal 328 to be transmitted on a clock line 318 of the serial bus 320. The bus master device 302 may include configuration registers 306 or other storage 324, and other control logic 312 configured to handle protocols and/or higher-level functions. The control logic 312 may include a processing circuit such as a state machine, sequencer, signal processor or general-purpose processor. The bus master device 302 includes a transceiver 310 and line drivers/receivers 314a and 314b. The transceiver 310 may include receiver, transmitter and common circuits, where the common circuits may include timing, logic and storage circuits and/or devices. In one example, the transmitter encodes and transmits data based on timing in the clock signal 328 provided by a clock generation circuit 308. Other timing clocks 326 may be used by the control logic 312 and other functions, circuits or modules.

At least one device 322₀-322_{N} may be configured to operate as a slave device on the serial bus 320 and may include circuits and modules that support a display, an image sensor, and/or circuits and modules that control and communicate with one or more sensors that measure environmental conditions. In one example, a slave device 322₀ configured to operate as a slave device may provide a control function, module or circuit 332 that includes circuits and modules to support a display, an image sensor, and/or circuits and modules that control and communicate with one or more sensors that measure environmental conditions. The slave device 322₀ may include configuration registers 334 or other storage 336, control logic 342, a transceiver 340 and line drivers/receivers 344a and 344b. The control logic 342 may include a processing circuit such as a state machine, sequencer, signal processor or general-purpose processor. The transceiver 310 may include receiver, transmitter and common circuits, where the common circuits may include timing, logic and storage circuits and/or devices. In one example, the transmitter encodes and transmits data based on timing in a clock signal 348 provided by clock generation and/or recovery circuits 346. The clock signal 348 may be derived from a signal received from the clock line 318. Other timing clocks 338 may be used by the control logic 342 and other functions, circuits or modules.

The serial bus 320 may be operated in accordance with RFFE, I2C, I3C, SPMI, or other protocols. At least one device 302, 322₀-322_{N} may be configured to operate as a master device and a slave device on the serial bus 320. Two or more devices 302, 322₀-322_{N} may be configured to operate as a master device on the serial bus 320.

In some implementations, the serial bus 320 may be operated in accordance with an I3C protocol. Devices that communicate using the I3C protocol can coexist on the same serial bus 320 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 320, in addition to data formats and aspects of bus control. In some aspects, the I2C and I3C protocols may define direct current (DC) characteristics affecting certain signal levels associated with the serial bus 320, and/or alternating current (AC) characteristics affecting certain timing aspects of signals transmitted on the serial bus 320. In some examples, a 2-wire serial bus 320 transmits data on a data line 316 and a clock signal on the clock line 318. In some instances, data may be encoded in the signaling state, or transitions in signaling state of the data line 316 and the clock line 318.

### Data Transfers Over a Serial Bus

Examples of data transfers including control signaling, command and payload transmissions are provided by way of example. The examples illustrated relate to I2C and I3C communication for convenience. However, certain concepts disclosed herein are applicable to other bus configurations and protocols, including RFFE and SPMI configurations.

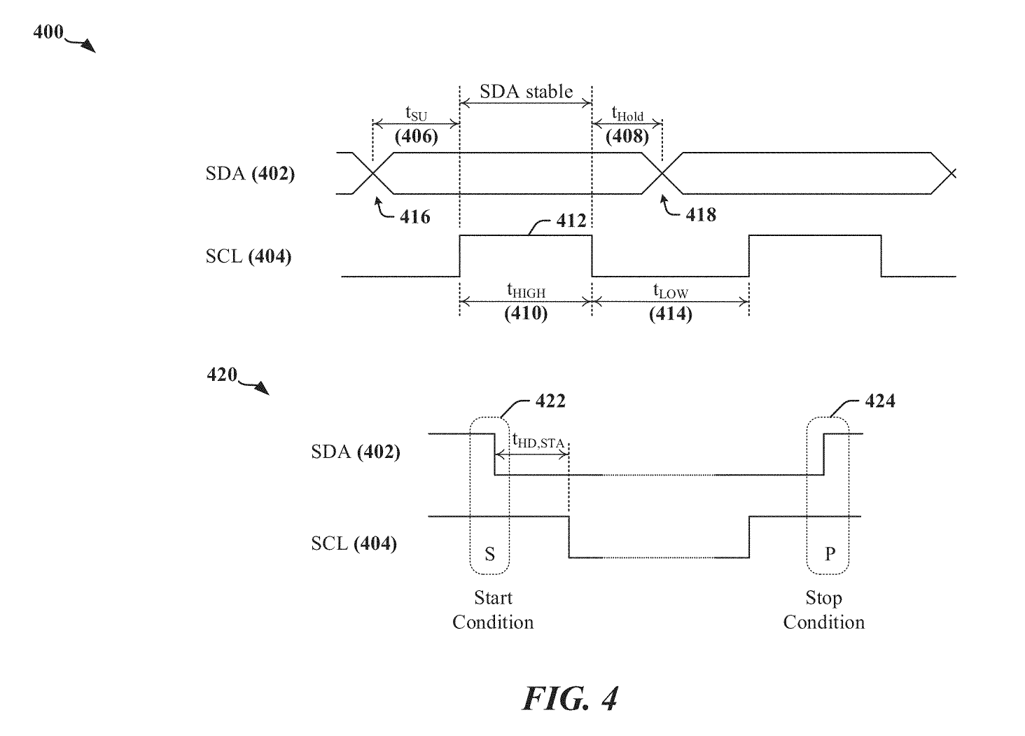

FIG. 4 includes timing diagrams 400 and 420 that illustrate the relationship between the SDA wire 402 and the SCL wire 404 on when the serial bus is operated in an I2C or I3C mode. The first timing diagram 400 illustrates the timing relationship between the SDA wire 402 and the SCL wire 404 while data is being transferred on the conventionally configured I2C bus. The SCL wire 404 provides a series of pulses that can be used to sample data in the SDA wire 402. The pulses (including the pulse 412, for example) may be defined as the time during which the SCL wire 404 is determined to be in a high logic state at a receiver. When the SCL wire 404 is in the high logic state during data transmission, data on the SDA wire 402 is required to be stable and valid; the state of the SDA wire 402 is not permitted to change when the SCL wire 404 is in the high logic state.

In one example, specifications for conventional I2C protocol implementations (which may be referred to as “I2C Specifications”) define a minimum duration 410 (t_{HIGH}) of the high period of the pulse 412 on the SCL wire 404. The I2C Specifications also define minimum durations for a setup time 406 (t_{SU}) before occurrence of the pulse 412, and a hold time 408 (t_{Hold}) after the pulse 412 terminates. The signaling state of the SDA wire 402 is expected to be stable during the setup time 406 and the hold time 408. The setup time 406 defines a maximum time period after a transition 416 between signaling states on the SDA wire 402 until the arrival of the rising edge of the pulse 412 on the SCL wire 404. The hold time 408 defines a minimum time period after the falling edge of the pulse 412 on the SCL wire 404 until a next transition 418 between signaling states on the SDA wire 402. The I2C Specifications also define a minimum duration 414 for a low period (t_{LOW}) for the SCL wire 404. The data on the SDA wire 402 is typically stable and/or can be captured for the duration 410 (t_{HIGH}) when the SCL wire 404 is in the high logic state after the leading edge of the pulse 412.

The second timing diagram 420 of FIG. 4 illustrates signaling states on the SDA wire 402 and the SCL wire 404 between data transmissions on a serial bus. Certain protocols provide for transmission of 8-bit data (bytes) and 7-bit addresses. A receiver may acknowledge transmissions by driving the SDA wire 402 to the low logic state for one clock period. The low signaling state represents an acknowledgement (ACK) indicating successful reception and a high signaling state represents a negative acknowledgement (NACK) indicating a failure to receive or an error in reception.

A start condition 422 is defined to permit the current bus master to signal that data is to be transmitted. The start condition 422 occurs when the SDA wire 402 transitions from high to low while the SCL wire 404 is high. The bus master initially transmits the start condition 422, which may be also be referred to as a start bit, followed by a 7-bit address of an I2C slave device with which it wishes to exchange data. The address is followed by a single bit that indicates whether a read or write operation is to occur. The addressed slave device, if available, responds with an ACK bit. If no slave device responds, the bus master may interpret the high logic state of the SDA wire 402 as a NACK. The master and slave devices may then exchange bytes of information in frames, in which the bytes are serialized such that the most significant bit (MSB) is transmitted first. The transmission of the byte is completed when a stop condition 424 is transmitted by the master device. The stop condition 424 occurs when the SDA wire 402 transitions from low to high while the SCL wire 404 is high.

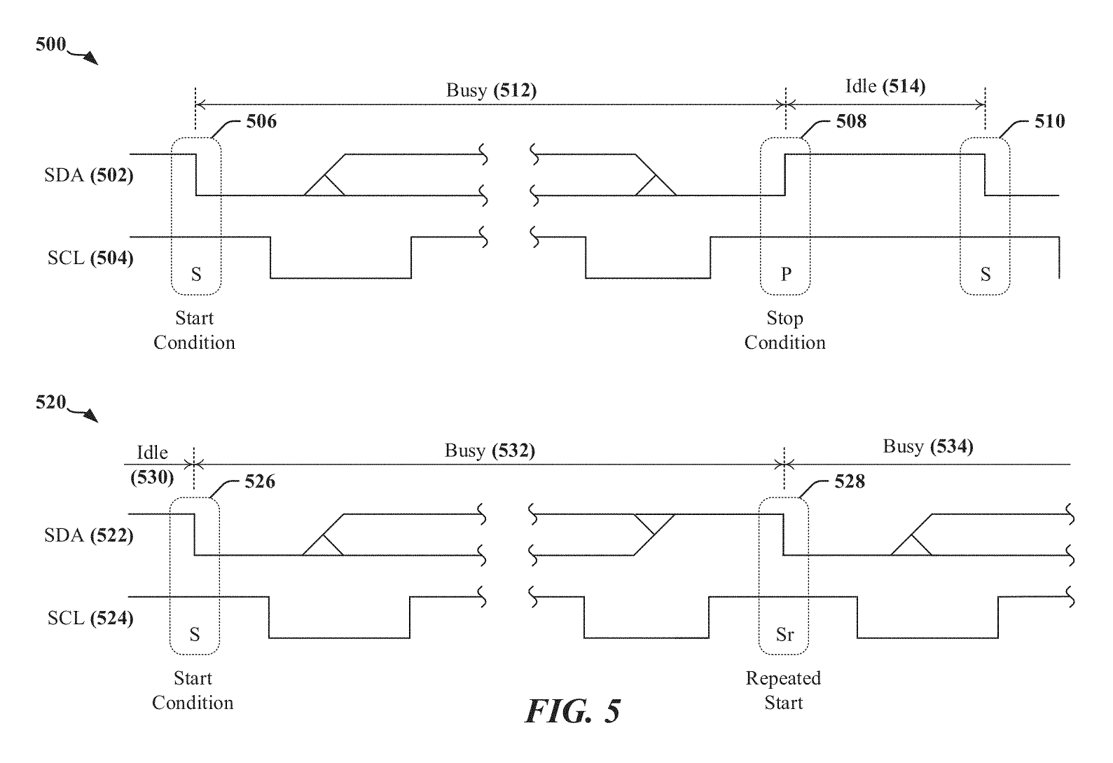

FIG. 5 includes diagrams 500 and 520 that illustrate timing associated with data transmissions on a serial bus operated in accordance with an I2C or I3C protocol. As illustrated in the first diagram 500, an idle period 514 may occur between a stop condition 508 and a consecutive start condition 510. In the illustrated example, the SDA line 502 and SCL line 504 may be held and/or driven to a high voltage state during the idle period 514. This idle period 514 may be prolonged, and may result in reduced data throughput when the serial bus remains idle between the stop condition 508 and the consecutive start condition 510. In operation, a busy period 512 commences when the I2C bus master transmits a first start condition 506, followed by data. The busy period 512 ends when the bus master transmits a stop condition 508 and the idle period 514 ensues. The idle period 514 ends when a second start condition 510 is transmitted.

The second timing diagram 520 illustrates a method by which the number of occurrences of an idle period 514 may be reduced. In the illustrated example, data is available for transmission before a first busy period 532 ends. The bus master device may transmit a repeated start condition 528 (Sr) rather than a stop condition. The repeated start condition 528 terminates the preceding data transmission and simultaneously indicates the commencement of a next data transmission. The state transition on the SDA wire 522 corresponding to the repeated start condition 528 is identical to the state transition on the SDA wire 522 for a start condition 526 that occurs after an idle period 530. For both the start condition 526 and the repeated start condition 528, the SDA wire 522 transitions from high to low while the SCL wire 524 is high. When a repeated start condition 528 is used between data transmissions, a first busy period 532 is immediately followed by a second busy period 534.

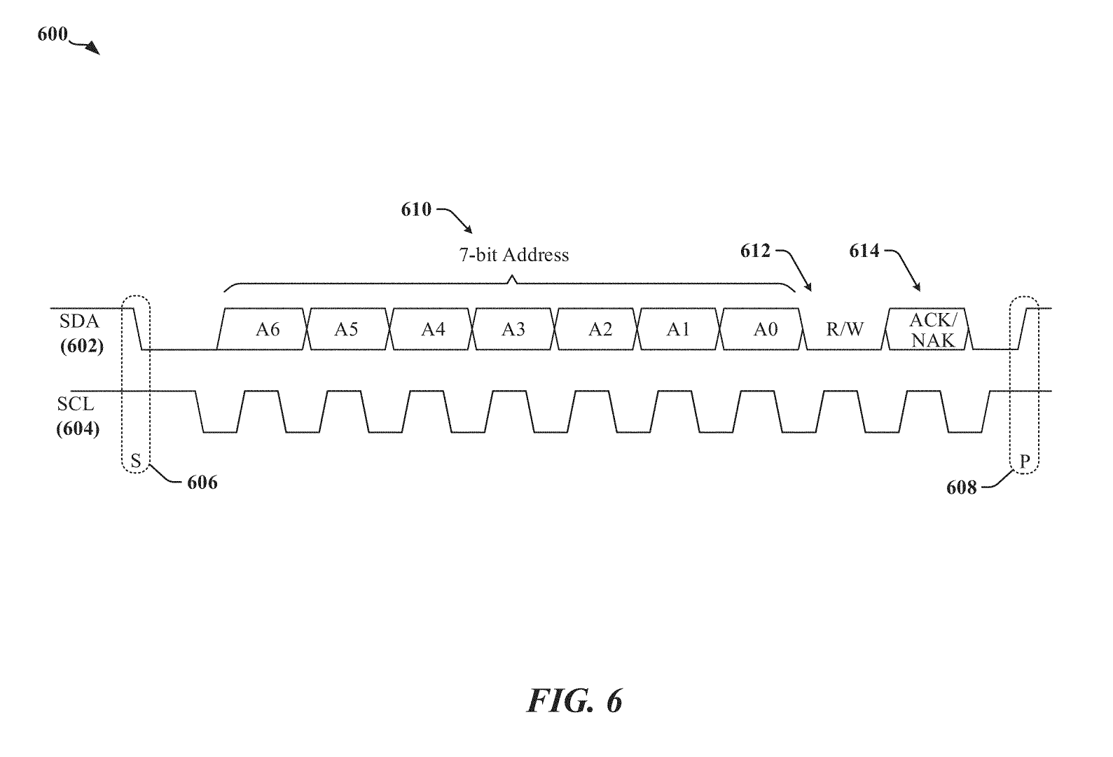

FIG. 6 is a diagram 600 that illustrates an example of the timing associated with an address word sent to a slave device in accordance with certain I2C and/or I3C protocols. In the example, a master device initiates the transaction with a start condition 606, whereby the SDA wire 602 is driven from high to low while the SCL wire remains high. The master device then transmits a clock signal on the SCL wire 604. The seven-bit address 610 of a slave device is then transmitted on the SDA wire 602. The seven-bit address 610 is followed by a Write/Read command bit 612, which indicates “Write” when low and “Read” when high. The slave device may respond in the next clock interval 614 with an acknowledgment (ACK) by driving the SDA wire 602 low. If the slave device does not respond, the SDA wire 602 is pulled high and the master device treats the lack of response as a NACK. The master device may terminate the transaction with a stop condition 608 by driving the SDA wire 602 from low to high while the SCL wire 604 is high. This transaction can be used to determine whether a slave device with the transmitted address coupled to the serial bus is in an active state.

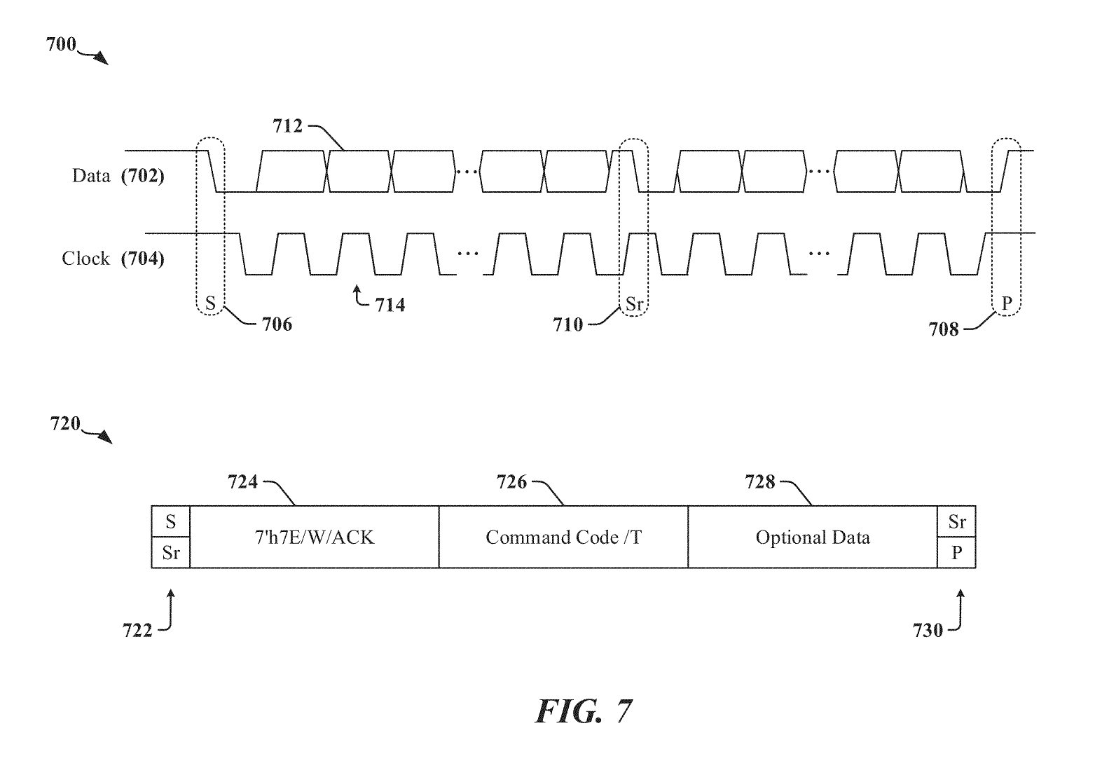

FIG. 7 includes a timing diagram 700 that illustrates signaling on a serial bus when the serial bus is operated in a single data rate (SDR) mode of operation defined by I3C specifications. Data transmitted on a first wire (the Data wire 702) of the serial bus may be captured using a clock signal transmitted on a second wire (the Clock wire 704) of the serial bus. During data transmission, the signaling state 712 of the Data wire 702 is expected to remain constant for the duration of the pulses 714 when the Clock wire 704 is at a high voltage level. Transitions on the Data wire 702 when the Clock wire 704 is at the high voltage level indicate a start condition (Start 706), a stop condition (Stop 708) or a Repeated Start 710.

On an I3C serial bus, a Start 706 is defined to permit the current bus master to signal that data is to be transmitted. The Start 706 occurs when the Data wire 702 transitions from high to low while the Clock wire 704 is high. The bus master may signal completion and/or termination of a transmission using a Stop 708. The Stop 708 is indicated when the Data wire 702 transitions from low to high while the Clock wire 704 is high. A Repeated Start 710 may be transmitted by a bus master that wishes to initiate a second transmission upon completion of a first transmission. The Repeated Start 710 is transmitted instead of, and has the significance of a Stop 708 followed immediately by a Start 706. The Repeated Start 710 occurs when the Data wire 702 transitions from high to low while the Clock wire 704 is high.

The bus master may transmit an initiator 722 that may be a Start 706 or a Repeated Start 710 prior to transmitting an address of a slave, a command, and/or data. FIG. 7 illustrates a command code transmission 720 by the bus master. The initiator 722 may be followed in transmission by an address header 724 and a command code 726. The command code 726 may, for example, cause the serial bus to transition to a desired mode of operation. In some instances, data 728 may be transmitted. The command code transmission 720 may be followed by a terminator 730 that may be a Stop 708 or a Repeated Start 710.

Certain serial bus interfaces support signaling schemes that provide higher data rates. In one example, I3C specifications define multiple high data rate (HDR) modes, including a high data rate, double data rate (HDR-DDR) mode in which data is transferred at both the rising edge and the falling edge of the clock signal.

### Address Arbitration on a Serial Bus

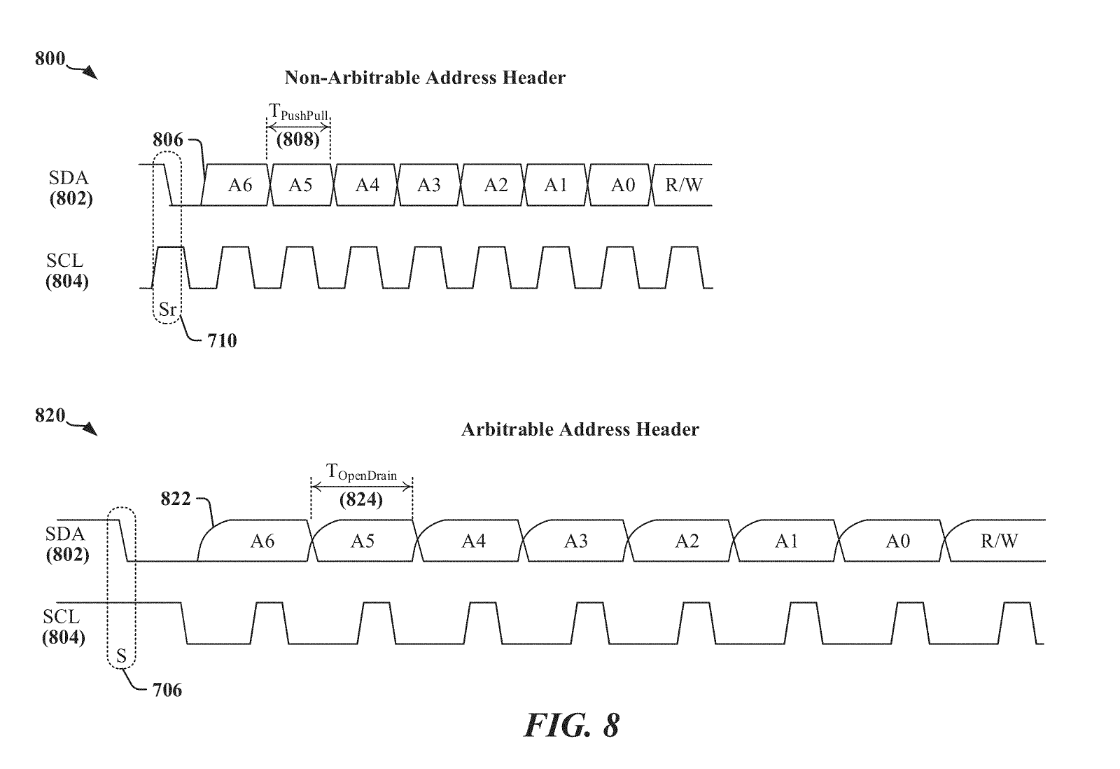

A device other than the current bus master may initiate an arbitration process to gain access to a serial bus during transmission of certain address fields. The serial bus may be operated in a mode in which data is transmitted on an SDA line 802 in accordance with timing provided by a clock signal transmitted on an SCL line 804. FIG. 8 illustrates a non-arbitrable address header 800 and an arbitrable address header 820 that may be transmitted on the SDA line 802 of the serial bus in accordance with I3C protocols. I3C protocols provide for different types of request to be transmitted using an I3C arbitrable address header. I3C arbitrable address headers 820 can be transmitted after a Start 706. An address header 724 transmitted after a Repeated Start 710 is not arbitrable. A device may use an I3C arbitrable address header to assert an In-Band Interrupt, make a secondary master request, or indicate a hot-join request.

A non-arbitrable address header 800 is transmitted using push-pull drivers, while open-drain drivers are enabled during transmission of an arbitrable address header 820. Rising edges 806 in a push-pull transmission provide a shorter bit interval 808 than the bit interval 824 available during an open-drain transmission, due to the slow rise time of the pulled-up edges 822 in a non-arbitrable address header 800. In FIG. 8, the bit intervals 808, 824 are not depicted on a common scale. In one example, the shorter bit interval 808 has a duration of 80 ns, while the open-drain bit interval 824 has a duration of 240 ns. In the example, the total time required to transmit a 7-bit address with a read/write bit is 640 ns in push-pull mode, while the total time required to transmit a 7-bit address with a read/write bit is 1.92 μs.

Certain aspects of this disclosure an addressing scheme that can reduce the duration of an arbitrable address header 820. In one example, device addresses may be assigned to allow high priority devices to provide an early indication of end of arbitration. Upon ending arbitration, bit driving may be changed from open-drain mode to push-pull mode.

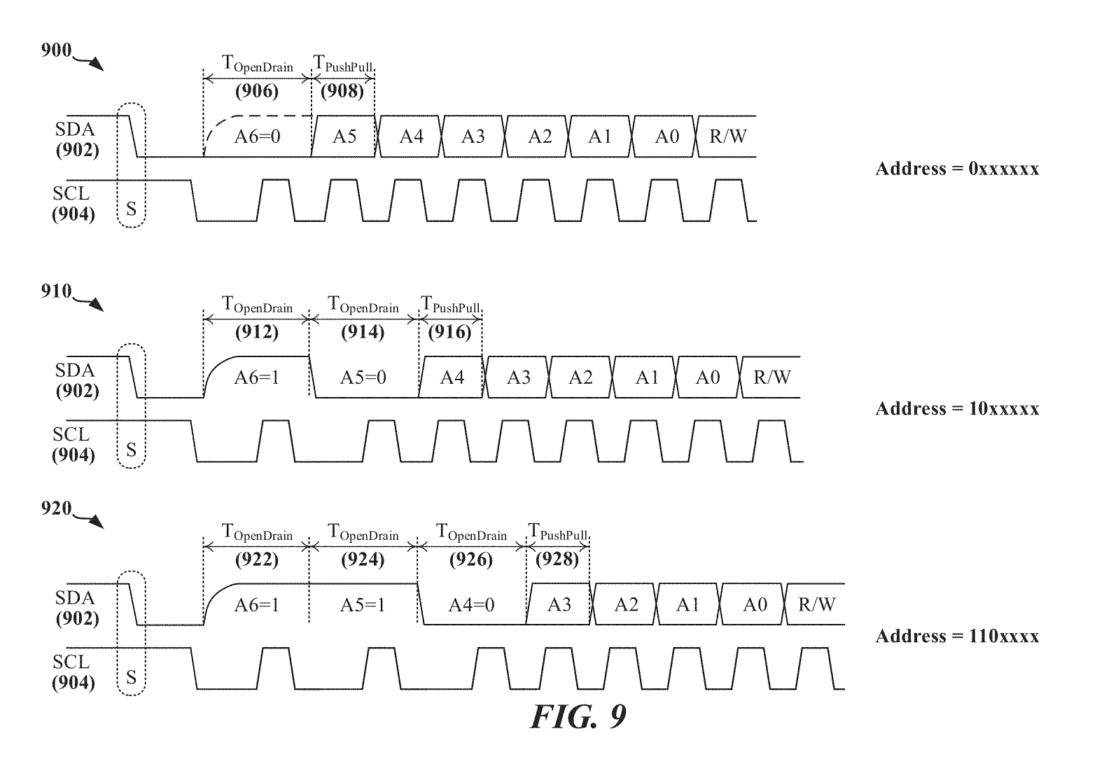

FIG. 9 illustrates timing of address arbitrations 900, 910, 920 won by high priority devices adapted or configured in accordance with certain aspects disclosed herein. In one aspect, an addressing scheme provides that higher-priority devices are assigned lower addresses. In the example depicted in FIG. 9, three high-priority addresses are assigned to devices other than the current bus master. In other examples, less than three or more than three devices may be assigned high-priority addresses. The number of high-priority addresses assigned may determine the maximum number of devices that can participate in address arbitration. In the illustrated example, devices that are not assigned high-priority addresses can have a binary address in the range 1110000b to 1111110b.

An address arbitration 900, 910, 920 is initiated when the master device enables an open-drain mode line driver coupled to SDA 902. The master device may reduce the rate at which pulses are transmitted on SCL 904 to accommodate the open-drain duration 906, 912, 914, 922, 924, 926. The first address arbitration 900 is won by a device that has an address with the most significant bit (MSB) set to ‘0’ (i.e., 0xxxxxx). The second address arbitration 910 is won by a device that has an address with the MSB set to ‘1’ and the second most significant bit set to ‘0’ (i.e., 10xxxxx). The third address arbitration 920 is won by a device that has an address with the MSB and second most significant bit both set to ‘1’ and the third most significant bit set to ‘0’ (i.e., 110xxxx).

The presence of a zero-value in any of the three most significant bits of the address field indicates that early termination of the address arbitration process may occur. The master device may configure its line driver for push-pull operation, and increases the rate at which pulses are transmitted on SCL 904 to match the push-pull duration 908, 916, 928. The number of bits transmitted with an open-drain duration 906, 912, 914, 922, 924, 926 is minimized for high-priority devices.

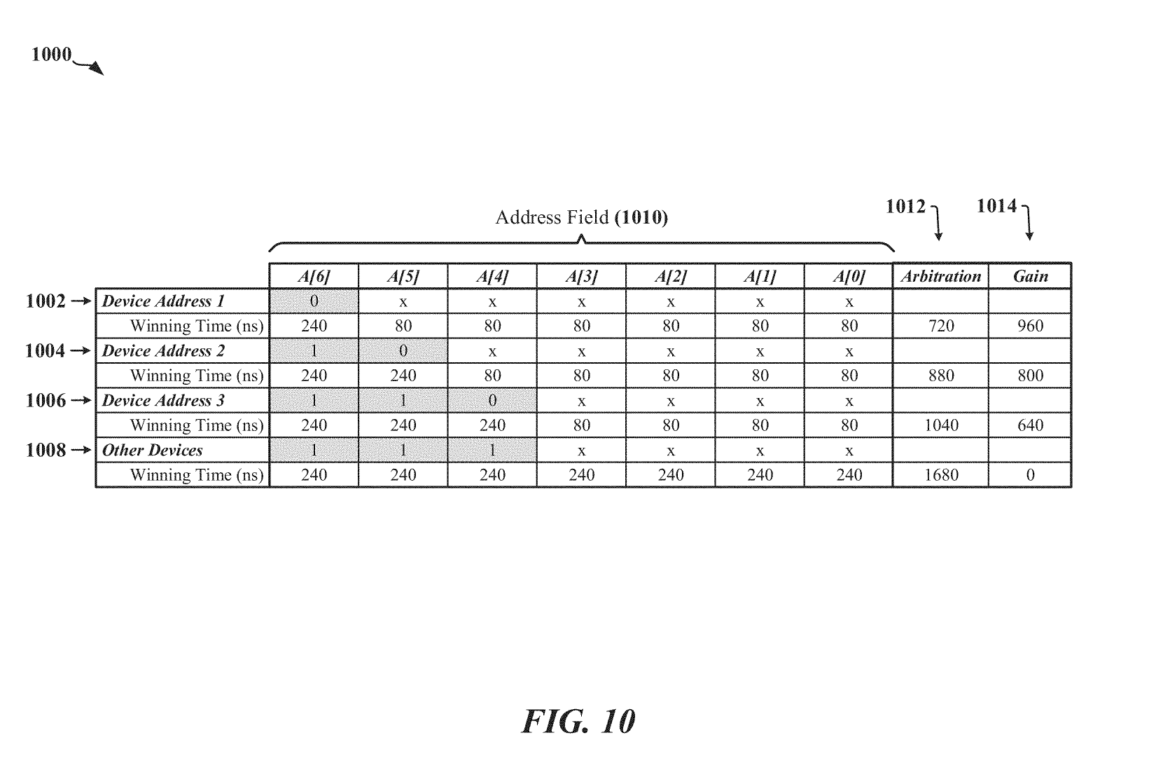

FIG. 10 is a table 1000 illustrating certain aspects of the address arbitrations 900, 910, 920 illustrated in FIG. 9. A first address 1002 is assigned to the device that wins the first address arbitration 900. A second address 1004 is assigned to the device that wins the second address arbitration 910. A third address 1006 is assigned to the device that wins the third address arbitration 910. A range of addresses 1008 may be assigned to other, low-priority devices. The table illustrates the time in nanoseconds used to transmit each bit for each address 1002, 1004, 1006, or range of addresses 1008. The arbitration time column 1012 lists the total time to transmit the address field 1010 for each address 1002, 1004, 1006, or range of addresses 1008, with the timing gain 1014 representing the saving in time over conventional address arbitrations that use open-drain throughout. The addressing scheme and corresponding address arbitration permits certain devices to be targeted for low-latency arbitration.

In some examples, address arbitration for devices that are not assigned high-priority addresses may be completed in open-drain mode. In other examples, optimization techniques may be implemented to reduce lower-priority arbitrations. For example, the addresses assigned to lower-priority devices may have a zero-value as the fourth most significant bit. In this example, the master device may terminate address arbitration mode when the master has detected that the first four bits of the address field 1010 have a non-zero value. A lower-priority device monitoring the serial bus during address arbitration may refrain from driving SDA 902 after detecting that another device has driven SDA 902 low. According to certain aspects, the lower-priority device may also configure its line driver for push-pull mode after detecting a transition to the low signaling state.

According to protocol, the slave devices cannot actively drive SDA 902 high, a slave device may pull SDA 902 low. The high signaling state on SDA 902 is obtained by using a pull-up structure that could be a fixed resistor or a switchable pull-up structure provided in the master device. The pull-up structure provides a weaker, slower transition than the actively driven low signaling state, and the low period of SCL 904 is prolonged. In one example, the duration of the low period in an I3C mode is typically 200 ns, providing a clock cycle having a 240 ns period when SCL 904 is in open-drain mode. In Push-pull mode, the clock cycle has an 80 ns period. The slave device must react to a low transition as fast as possible.

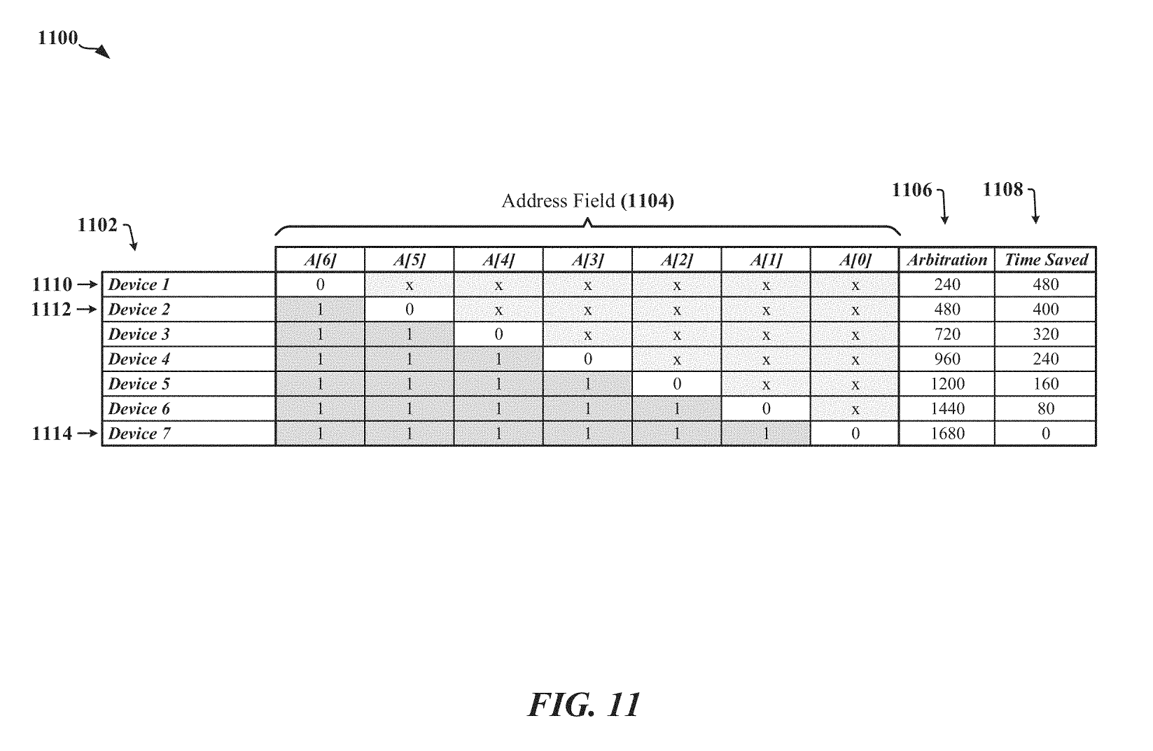

FIG. 11 is a table 1100 illustrating an addressing scheme that may be employed in accordance with certain aspects disclosed herein. The addressing scheme can provide certain latency reductions when implemented with a suitable adapted master device. In one example, addresses may be assigned to up to 7 devices (including higher priority devices 1110, 1112 and lower priority devices 1114). Each device 1102 is readily distinguishable based on the address transmitted on the serial bus during address arbitration. In the example, the highest priority device 1110 is the only device with an address that would cause SDA 902 to be driven low during the MSB transmission interval in address arbitration. The second highest priority device 1112 is the only device with an address that would cause SDA 902 to be driven low during the second most significant bit transmission interval in address arbitration, when the highest priority device 1110 is not participating in the address arbitration. A highest priority participating device 1102 can be uniquely identified based on the timing of the first low transmission on SDA 902 during address arbitration. The table 1100 provides a total address transmission time 1106 and savings 1108 accrued from reduced address arbitration times 1106 when early termination is employed and truncates the address field 1104.

According to certain aspects of this disclosure, address arbitration can be terminated early by transmission of a Stop after the first asserting device is recognized. Early termination may be restricted to in-band interrupts, and/or a hot-join request. In some circumstances, early termination may be permitted for secondary master request. Early termination may not be appropriate for slave-initiated address arbitration. For example, a slave device may not be adapted to support early termination.

In some implementations, a Stop may be used for early address arbitration termination when the current bus master intends to read a slave device that won the address arbitration. A repeated Start may be used for early address arbitration termination when the current bus master does not intend to read the slave device that won the address arbitration, but intends to address a different slave device of an address that is not associated with a device coupled to the serial bus.

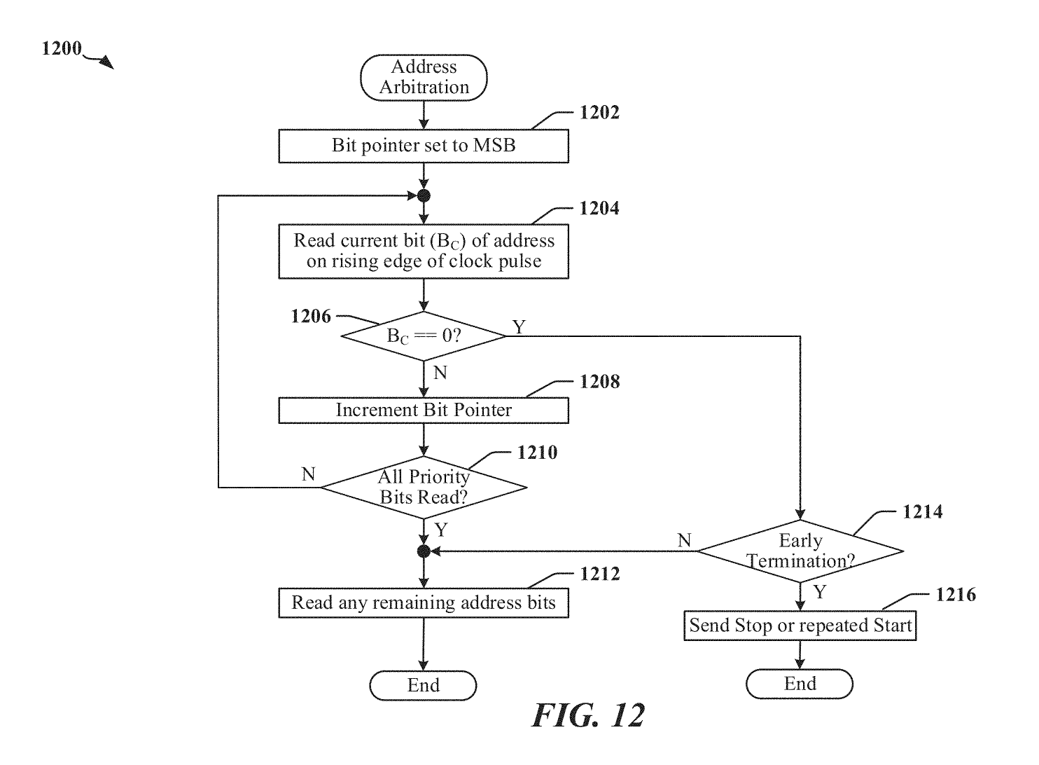

FIG. 12 is a flowchart 1200 illustrating certain aspects of an address arbitration performed by a master device in accordance with certain aspects disclosed herein.

At block 1202, the master device may initiate transmission of an arbitrable address header. A slave device or secondary master device may participate in address arbitration beginning with the first bit (MSB) of the address field. In the example, the master device tracks bit position in the address field using a pointer initialized to point to the MSB. At least one of the highest order bits, including the MSB, may be allocated to indicate a priority device. The master device disables push-pull mode and/or enables open-drain mode in the line driver coupled to SDA 902.

At block 1204, the master device may read a current bit of the address field on the rising edge of a clock pulse in SCL 904. At block 1206, the master device may determine whether the current bit has a zero-value, which may indicate that a high-priority device is attempting to win arbitration. If the current bit has a zero-value, the process continues at block 1214.

At block 1214, the master device may determine if early termination of address arbitration is configured. Early termination may be configured for all arbitration processes, for certain types of arbitration processes and/or for certain addresses corresponding to devices that win the arbitration. If early termination of address arbitration has been configured, then the master device may send a Stop or repeated Start at block 1216 to terminate the process. If early termination of address arbitration is not configured the process may terminate after reading of the complete address field at block 1212.

If at block 1206, the master device determines that the current bit has a non-zero value, the process continues at block 1208, where the bit pointer is incremented to the next bit. At block 1210, the master device may determine, using the bit pointer or otherwise, whether all priority bits have been read. If more address bits associated with high-priority devices remain to be potentially transmitted by a requesting device, the process resumes at block 1204. When no more address bits associated with high-priority devices remain to be potentially transmitted, the process may terminate after reading of the complete address field at block 1212.

When early termination is configured, the master device may take control of SDA 902 immediately after determining that the current bit has a zero value. Devices that have not driven SDA 902 have lost arbitration and do not attempt to take control of SDA 902 during the remainder of the arbitration process. On the falling edge of the pulse on SCL 904, the device that drove the current bit value to zero releases SDA 902 and does not attempt to transmit additional address bits. Any early termination occurs after the first zero-value address bit has been transmitted.

At block 1216, the early termination may be effected using a Stop or repeated Start. When the master device intends to read from a slave device, the master device may provide a rising edge on a pulse transmitted on SCL 904 while SDA 902 is maintained in the low state. The master device may then transmit a Stop by driving SDA 902 high. Devices on the bus, with the exception of the Slave that requested the read through arbitration, reset their interface logic and wait for the next Start condition. The master device may provide a falling edge on SCL 904, which is ignored by conventional I3C or I2C slave devices. The master device may then provide pulses on SCL 904 to conduct a transaction. The transaction may include a read, a write or a combination of read and write. Provided the transaction remains in SDR mode, conventional slave devices are not influenced by the clock pulses. The type of transaction may be configured by the private contract between the master device and a corresponding slave device.

In some instances, a fastest arrangement is obtained when there is only one possible follow-up from an early termination. That is, the system may be configured to conduct either a read or write transaction, with the type of data having an agreed or configured meaning. In some instances, several possibilities are accommodated, where a code can be initially written to indicate the character of the remainder of the transaction. In one example, a nibble (4 bits) or less may be initially written. In other instances, the character of the remainder of the transaction may be communicated in other ways including, for example, using the timing of the early termination with respect to the “0” value, or after one SCL pulse.

When the master device does not intend to engage in a transaction with a slave device, the master device may drive SDA 902 high, while SCL 904 is low. The master device may then provide a rising edge of a pulse on SCL 904. The master device may provide a repeated Start, driving SDA 902 low while SCL 904 is high. Responsive to the repeated start, all devices on the serial bus monitor the serial bus to determine if their address is transmitted. The master device may provide a non-existent address followed by a Stop, or a valid slave address followed by a communication with that corresponding slave device.

In one example, when the master device intends to engage in a write transaction with the slave device that won arbitration, the master device may provide a pulse on SCL 904, and refrains from changing the level of SDA 902 while SCL 904 is high. The slave device that won arbitration recognizes that the master device intends to transmit, and consequently does not drive SDA 902 during data transfer (except for ACK/NACK signaling as provided). The master device may provide a STOP condition in order to reset conventional slave devices. The master device may then write data to the slave device using signaling similar to the signaling used to read the slave device that won arbitration.

### Examples of Processing Circuits and Methods

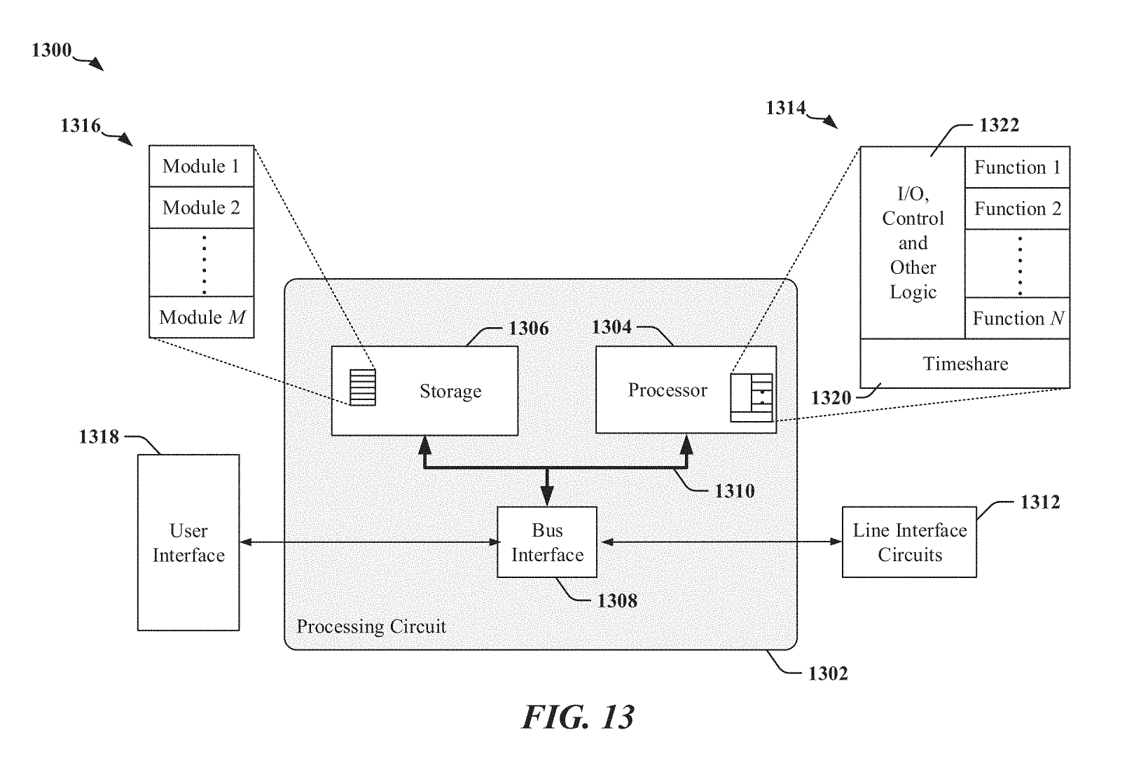

FIG. 13 is a diagram illustrating an example of a hardware implementation for an apparatus 1300 employing a processing circuit 1302 that may be configured to perform one or more functions disclosed herein. In accordance with various aspects of the disclosure, an element, or any portion of an element, or any combination of elements as disclosed herein may be implemented using the processing circuit 1302. The processing circuit 1302 may include one or more processors 1304 that are controlled by some combination of hardware and software modules. Examples of processors 1304 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1304 may include specialized processors that perform specific functions, and that may be configured, augmented or controlled by one of the software modules 1316. The one or more processors 1304 may be configured through a combination of software modules 1316 loaded during initialization, and further configured by loading or unloading one or more software modules 1316 during operation. In various examples, the processing circuit 1302 may be implemented using a state machine, sequencer, signal processor and/or general-purpose processor, or a combination of such devices and circuits.

In the illustrated example, the processing circuit 1302 may be implemented with a bus architecture, represented generally by the bus 1310. The bus 1310 may include any number of interconnecting buses and bridges depending on the specific application of the processing circuit 1302 and the overall design constraints. The bus 1310 links together various circuits including the one or more processors 1304, and storage 1306. Storage 1306 may include memory devices and mass storage devices, and may be referred to herein as computer-readable media and/or processor-readable media. The bus 1310 may also link various other circuits such as timing sources, timers, peripherals, voltage regulators, and power management circuits. A bus interface 1308 may provide an interface between the bus 1310 and one or more transceivers 1312. A transceiver 1312 may be provided for each networking technology supported by the processing circuit. In some instances, multiple networking technologies may share some or all of the circuitry or processing modules found in a transceiver 1312. Each transceiver 1312 provides a means for communicating with various other apparatus over a transmission medium. Depending upon the nature of the apparatus 1300, a user interface 1318 (e.g., keypad, display, speaker, microphone, joystick) may also be provided, and may be communicatively coupled to the bus 1310 directly or through the bus interface 1308.

A processor 1304 may be responsible for managing the bus 1310 and for general processing that may include the execution of software stored in a computer-readable medium that may include the storage 1306. In this respect, the processing circuit 1302, including the processor 1304, may be used to implement any of the methods, functions and techniques disclosed herein. The storage 1306 may be used for storing data that is manipulated by the processor 1304 when executing software, and the software may be configured to implement any one of the methods disclosed herein.

One or more processors 1304 in the processing circuit 1302 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1306 or in an external computer-readable medium. The external computer-readable medium and/or storage 1306 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1306 may also include, by way of example, a carrier wave, a transmission line, and any other suitable medium for transmitting software and/or instructions that may be accessed and read by a computer. Computer-readable medium and/or the storage 1306 may reside in the processing circuit 1302, in the processor 1304, external to the processing circuit 1302, or be distributed across multiple entities including the processing circuit 1302. The computer-readable medium and/or storage 1306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1306 may maintain software maintained and/or organized in loadable code segments, modules, applications, programs, etc., which may be referred to herein as software modules 1316. Each of the software modules 1316 may include instructions and data that, when installed or loaded on the processing circuit 1302 and executed by the one or more processors 1304, contribute to a run-time image 1314 that controls the operation of the one or more processors 1304. When executed, certain instructions may cause the processing circuit 1302 to perform functions in accordance with certain methods, algorithms and processes described herein.

Some of the software modules 1316 may be loaded during initialization of the processing circuit 1302, and these software modules 1316 may configure the processing circuit 1302 to enable performance of the various functions disclosed herein. For example, some software modules 1316 may configure internal devices and/or logic circuits 1322 of the processor 1304, and may manage access to external devices such as the transceiver 1312, the bus interface 1308, the user interface 1318, timers, mathematical coprocessors, and so on. The software modules 1316 may include a control program and/or an operating system that interacts with interrupt handlers and device drivers, and that controls access to various resources provided by the processing circuit 1302. The resources may include memory, processing time, access to the transceiver 1312, the user interface 1318, and so on.

One or more processors 1304 of the processing circuit 1302 may be multifunctional, whereby some of the software modules 1316 are loaded and configured to perform different functions or different instances of the same function. The one or more processors 1304 may additionally be adapted to manage background tasks initiated in response to inputs from the user interface 1318, the transceiver 1312, and device drivers, for example. To support the performance of multiple functions, the one or more processors 1304 may be configured to provide a multitasking environment, whereby each of a plurality of functions is implemented as a set of tasks serviced by the one or more processors 1304 as needed or desired. In one example, the multitasking environment may be implemented using a timesharing program 1320 that passes control of a processor 1304 between different tasks, whereby each task returns control of the one or more processors 1304 to the timesharing program 1320 upon completion of any outstanding operations and/or in response to an input such as an interrupt. When a task has control of the one or more processors 1304, the processing circuit is effectively specialized for the purposes addressed by the function associated with the controlling task. The timesharing program 1320 may include an operating system, a main loop that transfers control on a round-robin basis, a function that allocates control of the one or more processors 1304 in accordance with a prioritization of the functions, and/or an interrupt driven main loop that responds to external events by providing control of the one or more processors 1304 to a handling function.

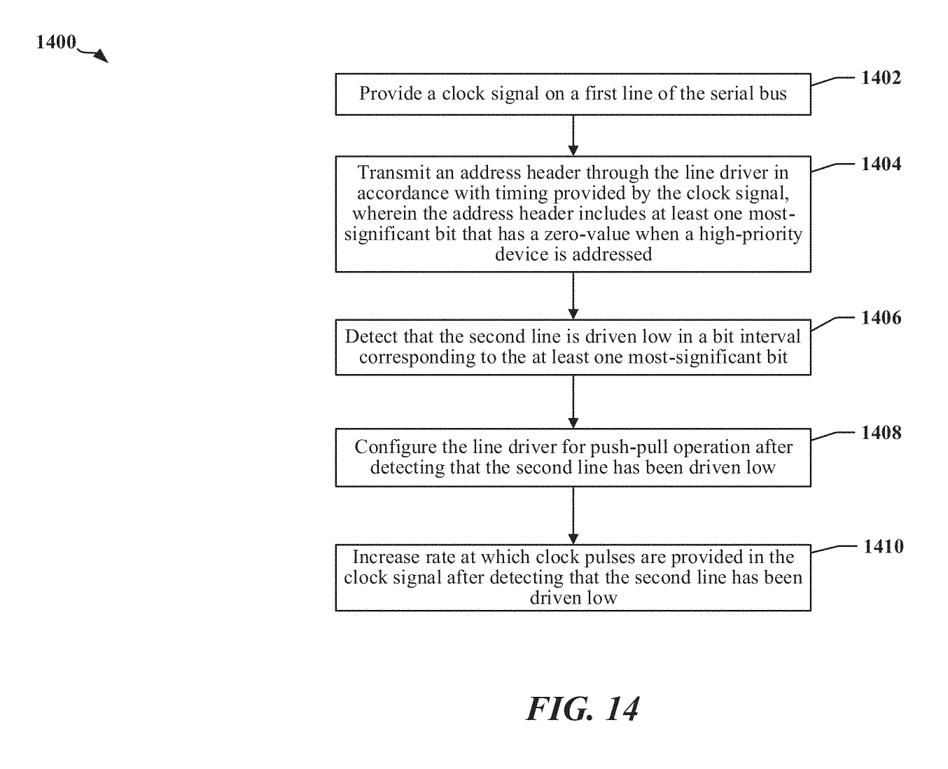

FIG. 14 is a flowchart 1400 illustrating a process that may be performed at a master device coupled to a serial bus. The process may be directed to arbitrate access to a serial bus. At block 1402, the master device may provide a clock signal on a first line of the serial bus. At block 1404, the master device may configure a line driver coupled to a second line of the serial bus for open-drain operation. At block 1406, the master device may transmit an address header through the line driver in accordance with timing provided by the clock signal. The address header may include at least one most-significant bit that has a zero-value when a high-priority device is addressed. At block 1408, the master device may detect that the second line is driven low in a bit interval corresponding to the at least one most-significant bit. At block 1410, the master device may configure the line driver for push-pull operation after detecting that the second line has been driven low. At block 1412, the master device may increase rate at which clock pulses are provided in the clock signal after detecting that the second line has been driven low.

In some examples, the master device may initiate a data transfer involving the high-priority device after detecting that the second line has been driven low. The data transfer may be initiated after completion of transmission of the address header.

In some examples, the master device may cause a data exchange involving the high-priority device and a slave device after detecting that the second line has been driven low. The data exchange may be initiated after completion of transmission of the address header.

In some examples, the master device may transmit a stop condition configured to terminate transmission of the address header after detecting that the second line has been driven low. The master device may initiate a transaction to read data from the high-priority device after transmitting the stop condition.

In some examples, the master device may drive the second line low for at least one cycle of the clock signal after detecting that the second line has been driven low. The master device may initiate a transaction to write data to the high-priority device after expiration of the at least one cycle of the clock signal.

In some examples, the master device may transmit a repeated start condition after detecting that the second line has been driven low. The repeated start condition may be configured to terminate transmission of the address header. The master device may transmit a stop condition after transmitting the repeated start condition. The \master device may initiate a transaction to read data from a slave device other than the high-priority device after transmitting the stop condition.

In some examples, two or more high-priority devices are coupled to the serial bus. Each high-priority device may be configured with a device address that has one zero-value most-significant bit. Two or more high-priority devices may be configured with device addresses that have different zero-value most-significant bits.

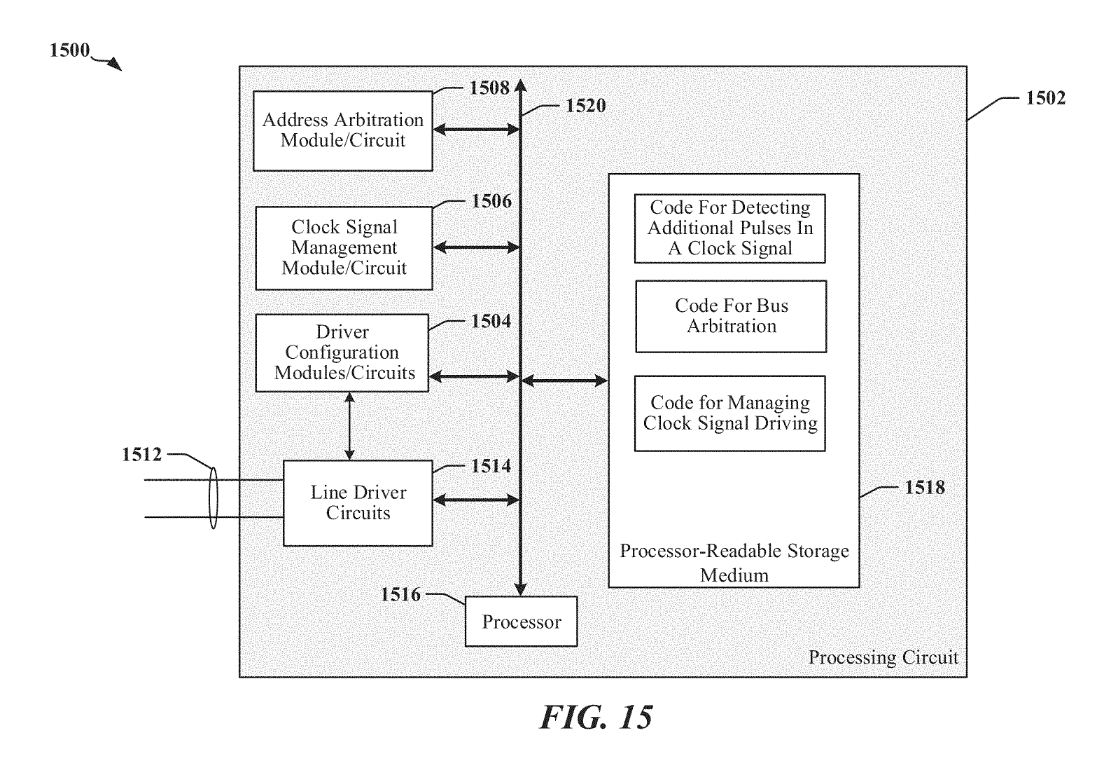

FIG. 15 is a diagram illustrating a simplified example of a hardware implementation for an apparatus 1500 employing a processing circuit 1502. The processing circuit typically has a controller or processor 1516 that may include one or more microprocessors, microcontrollers, digital signal processors, sequencers and/or state machines. The processing circuit 1502 may be implemented with a bus architecture, represented generally by the bus 1520. The bus 1520 may include any number of interconnecting buses and bridges depending on the specific application of the processing circuit 1502 and the overall design constraints. The bus 1520 links together various circuits including one or more processors and/or hardware modules, represented by the controller or processor 1516, the modules or circuits 1504, 1506 and 1508, and the processor-readable storage medium 1518. The apparatus may be coupled to a multi-wire communication link using a physical layer circuit 1514. The physical layer circuit 1514 may operate the multi-wire serial bus 1512 to support communications in accordance with I3C protocols. The bus 1520 may also link various other circuits such as timing sources, peripherals, voltage regulators, and power management circuits, which are well known in the art, and therefore, will not be described any further.

The processor 1516 is responsible for general processing, including the execution of software, code and/or instructions stored on the processor-readable storage medium 1518. The computer-readable storage medium may include a non-transitory storage medium. The software, when executed by the processor 1516, causes the processing circuit 1502 to perform the various functions described supra for any particular apparatus. The computer-readable storage medium may be used for storing data that is manipulated by the processor 1516 when executing software. The processing circuit 1502 further includes at least one of the modules 1504, 1506 and 1508. The modules 1504, 1506 and 1508 may be software modules running in the processor 1516, resident/stored in the processor-readable storage medium 1518, one or more hardware modules coupled to the processor 1516, or some combination thereof. The modules 1504, 1506 and 1508 may include microcontroller instructions, state machine configuration parameters, or some combination thereof.

In one configuration, the apparatus 1500 includes physical layer circuit 1514 that may include one or more line driver circuits including a first line driver coupled to a first wire of a multi-wire serial bus and a second line driver coupled to a second wire of the multi-wire serial bus 1512, and line driver configuration modules and/or circuits 1506. In one example, the line driver configuration modules and/or circuits 1506 may cause one or more of the line driver circuits to operate in a push-pull and/or open-drain mode. The apparatus 1500 may include modules and/or circuits 1508 configured to arbitrate between devices contending for access to the serial bus.

In one example, the apparatus 1500 includes a controller configured to provide the clock signal, configure one of the line driver circuits for open-drain operation, and transmit an address header through the line driver circuits in accordance with timing provided by the clock signal. The address header may include at least one most-significant bit that has a zero-value when a high-priority device is addressed. The controller may be configured to detect that the second line is driven low in a bit interval corresponding to the at least one most-significant bit, configure the line driver for push-pull operation after detecting that the second line has been driven low, and increase rate at which clock pulses are provided in the clock signal after detecting that the second line has been driven low.

The controller may be configured to initiate a data transfer involving the high-priority device after detecting that the second line has been driven low. The data transfer may be initiated after completion of transmission of the address header.

The controller may be configured to cause a data exchange involving the high-priority device and a slave device after detecting that the second line has been driven low. The data exchange may be initiated after completion of transmission of the address header.

The controller may be configured to transmit a stop condition configured to terminate transmission of the address header after detecting that the second line has been driven low, and initiate a transaction to read data from the high-priority device after transmitting the stop condition.

The controller may be configured to drive the second line low for at least one cycle of the clock signal after detecting that the second line has been driven low, and initiate a transaction to write data to the high-priority device after expiration of the at least one cycle of the clock signal.

The controller may be configured to transmit a repeated start condition after detecting that the second line has been driven low. The repeated start condition may be configured to terminate transmission of the address header. The controller may be configured to transmit a stop condition after transmitting the repeated start condition, and initiate a transaction to read data from a slave device other than the high-priority device after transmitting the stop condition.

In some examples, two or more high-priority devices are coupled to the serial bus. Each high-priority device may be configured with a device address that has one zero-value most-significant bit. Two or more high-priority devices may be configured with device addresses that have different zero-value most-significant bits.

In another example, the processor-readable storage medium 1518 may store, maintain or otherwise include code which, when executed by the processor 1516, causes the processor 1516 to provide a clock signal on a first line of a serial bus that provides multiple data lanes, configure a line driver coupled to a second line of the serial bus for open-drain operation, transmit an address header through the line driver in accordance with timing provided by the clock signal, detect that the second line is driven low in a bit interval corresponding to the at least one most-significant bit, configure the line driver for push-pull operation after detecting that the second line has been driven low, and increase rate at which clock pulses are provided in the clock signal after detecting that the second line has been driven low. The address header may include at least one most-significant bit that has a zero-value when a high-priority device is addressed.

The processor-readable storage medium 1518 may include code that causes the processor 1516 to initiate a data transfer or data exchange involving the high-priority device after detecting that the second line has been driven low. The data transfer or data exchange may be initiated after completion of transmission of the address header. The processor-readable storage medium 1518 may include code that causes the processor 1516 to transmit a stop condition configured to terminate transmission of the address header after detecting that the second line has been driven low, and initiate a transaction to read data from the high-priority device after transmitting the stop condition.

The processor-readable storage medium 1518 may include code that causes the processor 1516 to drive the second line low for at least one cycle of the clock signal after detecting that the second line has been driven low, and initiate a transaction to write data to the high-priority device after expiration of the at least one cycle of the clock signal.

The processor-readable storage medium 1518 may include code that causes the processor 1516 to transmit a repeated start condition after detecting that the second line has been driven low, transmit a stop condition after transmitting the repeated start condition, and initiate a transaction to read data from a slave device other than the high-priority device after transmitting the stop condition. The repeated start condition may be configured to terminate transmission of the address header.

In some examples, two or more high-priority devices are coupled to the serial bus and each high-priority device is configured with a device address that has one zero-value most-significant bit. Two or more high-priority devices may be configured with device addresses that have different zero-value most-significant bits.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for arbitrating access to a serial bus comprising:
providing a clock signal on a first line of the serial bus;
configuring a line driver coupled to a second line of the serial bus for open-drain operation;
transmitting an address header through the line driver in accordance with timing provided by the clock signal, wherein the address header includes at least one most-significant bit that has a zero-value when a high-priority device is addressed;
detecting that the second line is driven low in a bit interval corresponding to the at least one most-significant bit;
configuring the line driver for push-pull operation after detecting that the second line has been driven low; and
increasing rate at which clock pulses are provided in the clock signal after detecting that the second line has been driven low.

2. The method of claim 1, further comprising:
initiating a data transfer involving the high-priority device after detecting that the second line has been driven low.

3. The method of claim 2, wherein the data transfer is initiated after completion of transmission of the address header.

4. The method of claim 1, further comprising:
causing a data exchange involving the high-priority device and a slave device after detecting that the second line has been driven low.

5. The method of claim 4, wherein the data exchange is initiated after completion of transmission of the address header.

6. The method of claim 1, further comprising:
transmitting a stop condition configured to terminate transmission of the address header after detecting that the second line has been driven low; and
initiating a transaction to read data from the high-priority device after transmitting the stop condition.

7. The method of claim 1, further comprising:
driving the second line low for at least one cycle of the clock signal after detecting that the second line has been driven low; and
initiating a transaction to write data to the high-priority device after expiration of the at least one cycle of the clock signal.

8. The method of claim 1, further comprising:
transmitting a repeated start condition after detecting that the second line has been driven low, wherein the repeated start condition is configured to terminate transmission of the address header; and
initiating a transaction to read data from a slave device other than the high-priority device after transmitting the repeated start condition.

9. The method of claim 1, wherein two or more high-priority devices are coupled to the serial bus, wherein each high-priority device is configured with a device address that has one zero-value most-significant bit.

10. The method of claim 9, wherein the two or more high-priority devices are configured with device addresses that have different zero-value most-significant bits.

11. An apparatus, comprising:
a bus interface configured to couple the apparatus to a serial bus having a first line configured to carry a clock signal, the bus interface including a line driver adapted to drive a second line of the serial bus; and
a controller configured to:
provide the clock signal;
configure the line driver for open-drain operation;
transmit an address header through the line driver in accordance with timing provided by the clock signal, wherein the address header includes at least one most-significant bit that has a zero-value when a high-priority device is addressed;
detect that the second line is driven low in a bit interval corresponding to the at least one most-significant bit;
configure the line driver for push-pull operation after detecting that the second line has been driven low; and
increase rate at which clock pulses are provided in the clock signal after detecting that the second line has been driven low.

12. The apparatus of claim 11, wherein the controller is further configured to:
initiate a data transfer involving the high-priority device after detecting that the second line has been driven low.

13. The apparatus of claim 12, wherein the data transfer is initiated after completion of transmission of the address header.

14. The apparatus of claim 11, wherein the controller is further configured to:
cause a data exchange involving the high-priority device and a slave device after detecting that the second line has been driven low.

15. The apparatus of claim 14, wherein the data exchange is initiated after completion of transmission of the address header.

16. The apparatus of claim 11, wherein the controller is further configured to:
transmit a stop condition configured to terminate transmission of the address header after detecting that the second line has been driven low; and
initiate a transaction to read data from the high-priority device after transmitting the stop condition.

17. The apparatus of claim 11, wherein the controller is further configured to:
drive the second line low for at least one cycle of the clock signal after detecting that the second line has been driven low; and
initiate a transaction to write data to the high-priority device after expiration of the at least one cycle of the clock signal.

18. The apparatus of claim 11, wherein the controller is further configured to:
transmit a repeated start condition after detecting that the second line has been driven low, wherein the repeated start condition is configured to terminate transmission of the address header; and
initiate a transaction to read data from a slave device other than the high-priority device after transmitting the repeated start condition.

19. The apparatus of claim 11, wherein two or more high-priority devices are coupled to the serial bus, wherein each high-priority device is configured with a device address that has one zero-value most-significant bit.

20. The apparatus of claim 19, wherein the two or more high-priority devices are configured with device addresses that have different zero-value most-significant bits.

21. A processor-readable storage medium including code which, when executed by a processor, causes the processor to:
provide a clock signal on a first line of a serial bus that provides multiple data lanes;
configure a line driver coupled to a second line of the serial bus for open-drain operation;
transmit an address header through the line driver in accordance with timing provided by the clock signal, wherein the address header includes at least one most-significant bit that has a zero-value when a high-priority device is addressed;
detect that the second line is driven low in a bit interval corresponding to the at least one most-significant bit;
configure the line driver for push-pull operation after detecting that the second line has been driven low; and
increase rate at which clock pulses are provided in the clock signal after detecting that the second line has been driven low.

22. The storage medium of claim 21, further comprising code that causes the processor to:
initiate a data transfer involving the high-priority device after detecting that the second line has been driven low, wherein the data transfer is initiated after completion of transmission of the address header.

23. The storage medium of claim 21, further comprising code that causes the processor to:
cause a data exchange involving the high-priority device and a slave device after detecting that the second line has been driven low.

24. The storage medium of claim 23, wherein the data exchange is initiated after completion of transmission of the address header.

25. The storage medium of claim 21, further comprising code that causes the processor to:
transmit a stop condition configured to terminate transmission of the address header after detecting that the second line has been driven low; and
initiate a transaction to read data from the high-priority device after transmitting the stop condition.

26. The storage medium of claim 21, further comprising code that causes the processor to:
drive the second line low for at least one cycle of the clock signal after detecting that the second line has been driven low; and
initiate a transaction to write data to the high-priority device after expiration of the at least one cycle of the clock signal.

27. The storage medium of claim 21, further comprising code that causes the processor to:
transmit a repeated start condition after detecting that the second line has been driven low, wherein the repeated start condition is configured to terminate transmission of the address header; and
initiate a transaction to read data from a slave device other than the high-priority device after transmitting the repeated start condition.

28. The storage medium of claim 21, wherein two or more high-priority devices are coupled to the serial bus, wherein each high-priority device is configured with a device address that has one zero-value most-significant bit.

29. The storage medium of claim 28, wherein the two or more high-priority devices are configured with device addresses that have different zero-value most-significant bits.

30. An apparatus comprising:
means for providing a clock signal on a first line of a serial bus that provides multiple data lanes;
means for configuring a line driver coupled to a second line of the serial bus for open-drain operation;
means for transmitting an address header through the line driver in accordance with timing provided by the clock signal, wherein the address header includes at least one most-significant bit that has a zero-value when a high-priority device is addressed;
means for detecting that the second line is driven low in a bit interval corresponding to the at least one most-significant bit;
means for configuring the line driver for push-pull operation after detecting that the second line has been driven low; and
means for increasing rate at which clock pulses are provided in the clock signal after detecting that the second line has been driven low.
